(19) United States
(12) Patent Application Publication
(10) Pub. No.: US 2021/0142422 A1
(43) Pub. Date: May 13, 2021

(54) COMPUTERIZED TRANSACTION OPTIMIZATION

(71) Applicant: International Business Machines Corporation, Armonk, NY (US)

(72) Inventors: Zhang Ming, Shanghai (CN); Hui Hui Zeng, Shanghai (CN); Lin Chen, Shanghai (CN); Ying Xiong, Shanghai (CN); Si Lu Qi, Changchun (CN)

(21) Appl. No.: 16/679,482

(22) Filed: Nov. 11, 2019

(51) Int. Cl. G06Q 40/00; G06F 16/22; G06F 16/23; G06F 16/28

(52) U.S. Cl. CPC G06Q 40/12; G06F 16/285; G06F 16/2379; G06F 16/2282

(57) ABSTRACT

Disclosed embodiments provide computerized transaction optimization. Embodiments can include compiling a list of transaction scenarios. A list of transaction types is identified based on the transaction scenarios. A list of subjects is identified from the transaction types. A transaction scenario table is then created, where the transaction scenario table includes an entry for transaction type. Multiple transaction type groups are formed, where each transaction type group includes multiple transaction types. A transaction type table is created, where the transaction type table includes the transaction type groups, and corresponding balance types. A list of artifacts is identified for one or more institutions. A mapping of artifacts to transaction types is then performed, where the transaction types are based on the transaction scenarios. In this way, a more comprehensive and improved understanding of products and services based on transaction rules is achieved.

### FIELD

The present invention relates generally to computer systems, and more particularly, to computer systems for computerized transaction optimization.

### BACKGROUND

In modern enterprise computer systems, a transaction processing system manages information which processes the data transaction in a database system that monitors transaction activity. There are many applications for such transactions. These include e-commerce, business, banking, medical records, reservation systems, and more. Transactions can be performed in a batch mode, where multiple transactions are processed in an instance, at some later time from when the transaction occurred. Alternatively, transactions can be processed in a real-time mode, where a transaction is processed at the time it occurs, with minimal time delay. In many cases, the response time of a transaction processing system is important because delays in transaction processing can be impacting to the end-user customer experience. It is therefore desirable to have improvements in computerized transaction optimization.

### SUMMARY

In one embodiment, there is provided a computer-implemented method for computerized transaction optimization, comprising: compiling a list of transaction scenarios; identifying a list of transaction types based on the transaction scenarios; identifying a list of subjects from the transaction types; creating a transaction scenario table, wherein the transaction scenario table includes an entry for transaction type; forming a plurality of transaction type groups, wherein each transaction type group of the plurality of transaction type groups includes a plurality of transaction types; creating a transaction type table, wherein the transaction type table includes the transaction type groups, and corresponding balance types; identifying a list of artifacts for one or more institutions; mapping artifacts to transaction types, wherein the transaction types are based on the transaction scenarios; creating a transaction scenario categorization table, wherein the transaction scenario categorization table includes an entry for a balance type; and updating the transaction type table in an electronic database with subject information based on the balance type of the transaction scenario categorization table in response to a processed transaction.

In another embodiment, there is provided an electronic computation device comprising: a processor; a memory coupled to the processor, the memory containing instructions, that when executed by the processor, cause the electronic computation device to: compile a list of transaction scenarios; identify a list of transaction types based on the transaction scenarios; identify a list of subjects from the transaction types; create a transaction scenario table, wherein the transaction scenario table includes an entry for transaction type; form a plurality of transaction type groups, wherein each transaction type group of the plurality of transaction type groups includes a plurality of transaction types; create a transaction type table, wherein the transaction type table includes the transaction type groups, and corresponding balance types; identify a list of artifacts for one or more institutions; map artifacts to transaction types, wherein the transaction types are based on the transaction scenarios; create a transaction scenario categorization table, wherein the transaction scenario categorization table includes an entry for a balance type; and update the transaction type table in an electronic database with subject information based on the balance type of the transaction scenario categorization table in response to a processed transaction.

In yet another embodiment, there is provided a computer program product for an electronic computation device comprising a computer readable storage medium having program instructions embodied therewith, the program instructions executable by a processor to cause the electronic computation device to: compile a list of transaction scenarios; identify a list of transaction types based on the transaction scenarios; identify a list of subjects from the transaction types; create a transaction scenario table, wherein the transaction scenario table includes an entry for transaction type; form a plurality of transaction type groups, wherein each transaction type group of the plurality of transaction type groups includes a plurality of transaction types; create a transaction type table, wherein the transaction type table includes the transaction type groups, and corresponding balance types; identify a list of artifacts for one or more institutions; map artifacts to transaction types, wherein the transaction types are based on the transaction scenarios; create a transaction scenario categorization table, wherein the transaction scenario categorization table includes an entry for a balance type; and update the transaction type table in an electronic database with subject information based on the balance type of the transaction scenario categorization table in response to a processed transaction.

### BRIEF DESCRIPTION OF THE DRAWINGS

Features of the disclosed embodiments will be more readily understood from the following detailed description of the various aspects of the invention taken in conjunction with the accompanying drawings.

FIG. 1 is an environment for embodiments of the present invention.

FIG. 2 is an exemplary transaction scenario table in accordance with embodiments of the present invention.

FIG. 3A is an exemplary transaction type table in an initial state, in accordance with embodiments of the present invention.

FIG. 3B is an exemplary transaction type table in a completed state, in accordance with embodiments of the present invention.

FIG. 4 is an exemplary artifact and transaction type mapping table in accordance with embodiments of the present invention.

FIG. 5 is an exemplary transaction scenario categorization table in accordance with embodiments of the present invention.

FIG. 6 shows table relationships in accordance with embodiments of the present invention.

FIG. 7 is a flowchart indicating process steps for embodiments of the present invention.

FIG. 8 is a block diagram of an exemplary client device.

FIG. 9 is an example of a scenario analysis in accordance with embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide techniques for computerized transaction optimization. Computer transactions often involve interfacing multiple computer systems. Sometimes these systems may span different organizations, institutions, and/or corporations. Furthermore, sometimes these systems may span different countries, states, provinces, and/or other jurisdictions. Normalizing and processing transactions in this environment with multiple sets of rules can be challenging. Disclosed embodiments utilize mapping conditions and table associations to perform additional processing to mitigate the aforementioned challenges.

One example of an industry facing such challenges is banking. Embodiments can include modeling bank accounting rules, and compiling a list of transaction scenarios. A list of transaction types is identified based on the transaction scenarios, which can include financial scenarios. A list of subjects is identified from the transaction types. A transaction scenario table is then created, where the transaction scenario table includes an entry for transaction type. Multiple transaction type groups are formed, where each transaction type group includes multiple transaction types. A transaction type table is created, where the transaction type table includes the transaction type groups, and corresponding balance types. A list of artifacts (e.g. products) is identified for one or more enterprise institutions, which can include, but are not limited to, banks. A computerized mapping of artifacts to transaction types is then performed, where the transaction types are based on the transaction scenarios. A transaction scenario categorization table is then created, wherein the transaction scenario categorization table includes an entry for a balance type. The transaction type table is then updated with subject information based on the balance type of the transaction scenario categorization table in response to a processed transaction. In this way, a more comprehensive and improved understanding of products, services, and corresponding transactions, based on transaction rules is achieved.

As enterprises such as e-commerce, and banks provide continuous services to customers, the underlying accounting process often relies on the core banking system, which brings pressure to business processing, as well as affects the development and growth of business. Therefore, techniques and systems for separating the business aspect, such as trading, and the underlying implementation of the transaction rules is provided. Disclosed embodiments utilize the flexible allocation of transaction entries, by building an independent, enterprise-level computerized transaction optimization engine, which can perform various tasks such as transaction rule mapping. In the current state of the art, there are great differences between different transaction processing systems, such as banking accounting systems, which brings great difficulties for system reform. One of the problems being faced in today's banking system is that the current accounting separation method does not provide adequate techniques for the configuration of accounting rules. When assembling the transaction processing of different banking systems, the rules may not align properly, causing potential instability, and increases the possibility of incomplete accounting entries. While examples disclosed herein describe some financial transaction scenarios, disclosed embodiments can be utilized in other industries, including, but not limited to, e-commerce, ticketing and reservation systems, lending systems, and/or social media systems.

Disclosed embodiments provide computerized transaction optimization. Embodiments can include a modeling assembly method of transaction rules, such as banking accounting rules. In embodiments, disclosed systems and techniques design and define transaction rule models, such as bank accounting rule models, and also techniques to further refine the elements of these models. Thus, disclosed embodiments provide a modeling assembly method of accounting rules, enabling a separation between accounting and other business activities, such as trading. Embodiments establish a parameter model in the transaction systems so that the transaction rules can be parametrically configured and optimized.

Disclosed embodiments perform a variety of processes to achieve the generation of the configuration of transaction rules. These can include determining the scope and mode of transaction processing system access. The connecting scope is the actual caller of a transaction processing system service interface. The connect mode of the transaction processing can be divided into an accounting flow mode and an accounting elements mode. The accounting flow mode has specific requirements for the flow of system transactions. With the accounting elements mode, the computerized transaction optimization engine can perform rules mapping and can also generate entries by directly providing elements of transactions.

The processes can further include determining the implementation scope of accounting subjects. In order to improve the management of internal accounts, there are two optimization principles adopted, the cancellation principle and the setting principle.

With the cancellation principle, internal accounts are replaced by contracts, and new internal accounts are no longer set up, which are accounted directly by subjects and replaced by registers. This is done to better reflect the comprehensive situation of transactions in a business process.

With the setting principle, there can be a few exceptions, where internal accounts are allowed to exist, such as when business operations require real-time balance information, care for more detailed information than the subjects, or increased control of the details of business logic. According to the principle of optimization, internal accounts are managed optimally, which determines the subjects used in the application and system, and provides a full list of subjects.

The processes can further include analyzing accounting scenarios and obtaining accounting scenario tables. For the identified accounting scenarios, they are summarized and described in terms of business, accounting requirements related to scenarios, subjects, and accounting effect, etc., which together constitute the transaction scenario table. Based on the elements of transaction scenarios, including, but not limited to, atomic actions, amount types, loan signs, subjects, balance types of subjects, and/or other dimensions, the transaction types and transaction types groups corresponding to a transaction scenario are defined.

The processes can further include determining transaction types according to trading artifacts and scenarios. In this process, the items which can be used as transaction (accounting) objects in the implementation subjects are mapped into transaction types. The transaction types are clustered by the amount type, subject, atomic action and accounting methods, according to the transaction scenario table and transaction type table. After determining the composition of the transaction type and the transaction type group in the transaction type table, the artifact and transaction type is mapped. Each application, based on different business attributes of artifacts, maps to the transaction types existing in the transaction type table.

The processes can further include configuring engine rules to obtain transaction scenario classification tables and supplementing the transaction type tables. An engine entry rule is the transaction rule for the minimum granularity of the transaction (such as transaction type, atomic action, and/or amount type). Through the combination of multiple entry rules configuration, the transaction scenario requirements are finally realized. The transaction of the smallest granularity in the transaction scenario table is summarized and forms the classification table of transaction scenarios. The transaction scenario categorization table is the source of recording rule parameters for the computerized transaction optimization engine. The computerized transaction optimization engine maintains the integrity and accuracy of bank rules. The transaction scenarios are categorized into different balance types that are used by the same transaction type/transaction type group under different accounting actions. These balance types are grouped into dimensions according to the transaction type/transaction type group, and added to the transaction type table.

Disclosed embodiments enable interaction between different systems when interfacing with the computerized transaction optimization engine, and can provide the flexible assembly of transaction rules without affecting the trading system, allowing a fast response to product innovation that is scalable to support expansion and development of the trading system.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

FIG. 1 is an environment 100 for embodiments of the present invention. Computerized transaction optimization engine 102 comprises a processor 140, a memory 142 coupled to the processor 140, and storage 144. Computerized transaction optimization 102 is an electronic computation device. The memory 142 contains instructions 147, that when executed by the processor 140, perform embodiments of the present invention. Memory 142 may include dynamic random-access memory (DRAM), static random-access memory (SRAM), magnetic storage, and/or a read only memory such as flash, EEPROM, optical storage, or other suitable memory. In some embodiments, the memory 142 may not be a transitory signal per se. In some embodiments, storage 144 may include one or more magnetic storage devices such as hard disk drives (HDDs). Storage 144 may additionally include one or more solid state drives (SSDs). Computerized transaction optimization engine 102 is connected to network 124, which can include the Internet, a wide area network, a local area network, or other suitable network.

The environment 100 includes database 114. Database 114 is an electronic database used by computerized transaction optimization engine 102 to store and retrieve various tables used for management of information for the computerized transaction optimization engine 102. In embodiments, the database 114 may be a relational database, such as a Structured Query Language (SQL) database. In some embodiments, database 114 may be a NoSQL database, Object-oriented database, hierarchical database, or other suitable type of database.

The environment 100 includes one or more enterprise computing systems 112. In practice, there can be multiple institutional accounting systems that the environment 100 may interface with, to obtain account and product information from various institutions.

The environment 100 may further include a client device 116. In embodiments, the client device 116 may include a desktop computer, laptop computer, smartphone, tablet computer, wearable computer, or other suitable computing device for interacting with the computerized transaction optimization engine 102. The client device 116 may use a variety of protocols and techniques for communicating with the computerized transaction optimization engine 102, including, but not limited to, HTML (Hypertext Markup Language), XML (Extensible Markup Language), SOAP (Simple Object Access Protocol), Java, JavaScript, JSON (JavaScript Object Notation), RESTful APIs, and/or other suitable techniques.

In some embodiments, the environment 100 may further include a machine learning system 122. The machine learning system 122 may include regression algorithms, classification algorithms, clustering techniques, anomaly detection techniques, neural networks, Bayesian filtering, and/or other suitable techniques to analyze the information in the enterprise computing system 112 to assist in categorizing the information.

In some embodiments, the environment 100 may further include a legal corpus 127. The legal corpus 127 may include laws, rules, and/or regulations for one or more jurisdictions. The jurisdictions can include nations, states, provinces, counties, cities, multinational jurisdictions, and/or other suitable jurisdictions. The information in legal corpus may be applied based on the location of one or more subjects of a transaction scenario. Such subjects can include, but are not limited to, entities such as cash in stock, individual monthly savings deposit, available funds, funds not yet available, restricted funds, and/or funds incurring penalty for early withdrawal. In some embodiments, mapping conditions may be used to process other metadata such as residence of an account holder, currency type, and/or location of an institution, such as a financial institution. For example, the United States, Canada, and China each have varying rules for financial institutions and/or account holders that can affect various transaction scenarios. By accounting for these types of subjects, improved accuracy and performance in generation and categorization of banking rules may be achieved.

The mapping conditions configured within the tables allows for scalability and flexibility in deployment of computerized transaction optimization. The mapping conditions can be used to identify various criteria that are associated with a transaction. Conditional statements denoted by the mapping conditions can be used to flag certain transactions as to if the transactions meet predetermined criteria or not. In this way, disclosed embodiments can improve the technical field of computerized transaction optimization.

FIG. 2 is an exemplary transaction scenario table 200 in accordance with embodiments of the present invention. Some table entries for table 200 may have blank (NULL) values. Column 202 comprises a transaction scenario field. In column 202, row 222, a transaction scenario of “Cash deposit” is shown. While two rows are shown in transaction scenario table 200, in practice, there can be many more rows, with each row corresponding to a different transaction scenario. Column 204 comprises an atomic action field. In column 204, row 224, a transaction scenario of “Deposit” is shown. In practice, there can be many more types of atomic actions that may be indicated in a transaction scenario table.

Column 206 comprises an amount type field. In column 206, row 224, an amount type of “Principal” is also shown. In practice, there can be many more different amount types that may be indicated in a transaction scenario table. These can include, but are not limited to, interest payment, fee, dividend, and/or refund.

Column 208 comprises an account action field. In column 208, row 222, an account action of “Debit” is shown. In column 208, row 224, an account action of “Credit” is shown. In practice, there can be other account actions that may be indicated in a transaction scenario table.

Column 210 comprises a balance type field. In column 210, row 222, a balance type of “Cash at the counter” is shown. In column 210, row 224, a balance type of “Principal” is shown. In practice, there can be other balance types that may be indicated in a transaction scenario table.

Column 212 comprises a transaction type field. In column 212, row 222, a transaction type of “Cash in stock” is shown. In column 212, row 224, a transaction type of “Monthly deposit” is shown. In practice, there can be other transaction types that may be indicated in a transaction scenario table.

Column 214 comprises a transaction type group field. In column 214, row 224, a transaction type group of “Interest bearing” is shown. In practice, there can be other transaction type groups that may be indicated in a transaction scenario table. Transaction type groups may include, but are not limited to, a transaction type group of “tax” and/or a transaction type group of “internal account.” The transaction type group field may be used to reference other database tables to the transaction scenario table in a relational database implementation.

In embodiments, forming transaction type groups includes forming an interest-bearing deposit group. In embodiments, forming transaction type groups includes forming a tax group.

FIG. 3A is an exemplary transaction type table 300 in accordance with embodiments of the present invention in an initial configuration. Column 301 comprises a transaction type field. In column 301, row 322, a transaction type of “Cash in stock” is shown. In column 301, row 324, a transaction type of “Individual monthly savings deposit” is shown. In practice, there can be many more transaction types in the transaction type table 300. Some table entries for table 300 may have blank (NULL) values. Some of the blank values are populated at a later stage in the process of disclosed embodiments.

Column 302 comprises a transaction type group field (see column 214 of FIG. 2). In column 302, row 324, a transaction type group of “Interest bearing” is shown. In practice, there can be other transaction type groups that may be indicated in a transaction scenario table. These transaction type groups can include, but are not limited to, a transaction type group of “tax” and/or a transaction type group of “internal account.” The transaction type group field may be used to reference other database tables to the transaction scenario table in a relational database implementation.

Column 304 comprises a first balance type name. In column 306, a corresponding name of subject for the first balance type is shown. Column 308 comprises a second balance type name. In column 310, a corresponding name of subject for the second balance type is shown. Column 312 comprises a third balance type name. In column 314, a corresponding name of subject for the third balance type is shown. In practice, there can be many more balance types and corresponding name of subject entries indicated in a transaction type table. Furthermore, while table 300 indicates three balance types and corresponding description fields, in practice there can be more or fewer than three balance types and corresponding name of subject entry fields.

FIG. 3B is an exemplary transaction type table 350 in accordance with embodiments of the present invention in a completed configuration. The information in completed transaction type table 350 can be based on information in a transaction scenario categorization table (shown in FIG. 5). Thus, in FIG. 3B, various entries that were blank (NULL) in table 300 are populated based on a transaction that occurred, based on data included in a transaction scenario categorization table (further described and shown in FIG. 5). Column 301 comprises a transaction type field. In column 301, row 322, a transaction type of “Cash in stock” is shown. In column 301, row 324, a transaction type of “Interest bearing deposit group” is shown. In practice, there can be many more transaction types in the transaction type table 350. Some table entries for table 350 may have blank (NULL) values. Column 302 comprises a transaction type group field (see column 214 of FIG. 2). In column 302, row 324, a transaction type group of “Interest bearing” is shown. In practice, there can be other transaction type groups that may be indicated in a transaction scenario table. These transaction type groups can include, but are not limited to, a transaction type group of “tax” and/or a transaction type group of “internal account.” The transaction type group field may be used to reference other database tables to the transaction scenario table in a relational database implementation.

Column 304 comprises a first balance type name. In column 304, row 322, a balance type name of “Principal” is shown. In column 306, row 322, a corresponding name of subject of “Available funds” is shown. Similarly, in column 304, row 324, a balance type name of “Principal” is shown, and in column 306, row 324, a corresponding name of subject of “Available funds” is shown.

Column 308 comprises a second balance type name. In column 308, row 322, a balance type name of “Pending funds” is shown. In column 310, row 322, a corresponding name of subject of “funds not yet available” is shown. Similarly, in column 308, row 324, a balance type name of “Pending funds” is shown, and in column 310, row 324, a corresponding name of subject of “funds not yet available” is shown.

Column 312 comprises a third balance type name. In column 312, row 322, a balance type name of “Restricted funds” is shown. In column 314, row 322, a corresponding name of subject of “Funds incurring penalty for early withdrawal” is shown. Similarly, in column 312, row 324, a balance type name of “Restricted funds” is shown, and in column 314, row 324, a corresponding name of subject of “Funds incurring penalty for early withdrawal” is shown.

In practice, there can be many more balance types and corresponding balance descriptions indicated in a transaction type table. Furthermore, while table 300 indicates three balance types and corresponding description fields, in practice there can be more or fewer than three balance types and corresponding descriptions fields.

FIG. 4 is an exemplary artifact and transaction type mapping table 400 in accordance with embodiments of the present invention. Column 402 comprises an artifact name field. In embodiments, the artifact may be a product. In column 402, row 422, an artifact name of “Deluxe Checking” is shown. In column 402, row 424, an artifact name of “Basic Saver” is shown. While two rows are shown in artifact and transaction type mapping table 400, in practice, there can be many more rows, with each row corresponding to a different mapping between an artifact and a transaction type.

Column 404 comprises a category of transaction types field. In column 404, row 422, a category of transaction types of “Salable products” is shown. In column 404, row 424 a category of transaction types of “Legacy Products” is shown. In practice, there can be many more categories of transaction types that may be indicated in an artifact and transaction type mapping table.

Column 406 comprises an object name field. In column 406, row 422, an object name of “Personal time deposit” is shown. In column 406, row 424, an object name of “Cash” is shown. In practice, there can be many more object names that may be indicated in an artifact and transaction type mapping table.

Column 408 comprises a first mapping condition. Mapping conditions couple a condition to a value with an operation code. This allows a flexible and extensible mapping of conditions to values with a variety of operations. For the first mapping condition, column 432 comprises the condition, column 434 comprises the operation code, and column 436 comprises the value. In column 432, row 422, there is a condition of “Deposit nature.” In column 434, row 422, there is an operation code of “equals” (=), and in column 436, row 422, there is a value of 1. Thus, the first mapping condition includes a deposit nature equal to 1. In embodiments, the condition may be a Boolean condition that can be set to 1 for true or 0 for false.

Column 410 comprises a second mapping condition. For the second mapping condition, column 442 comprises the condition, column 444 comprises the operation code, and column 446 comprises the value. In column 442, row 422, there is a condition of “Agreed period.” In column 444, row 422, there is an operation code of “equals” (=), and in column 446, row 422, there is a value of 1. Thus, the second mapping condition includes an agreed period equal to 1. In embodiments, the agreed period may be a Boolean condition that can be set to 1 for true or 0 for false.

Column 412 comprises a third mapping condition. For the third mapping condition, column 452 comprises the condition, column 454 comprises the operation code, and column 456 comprises the value. In column 452, row 422, there is a condition of “Currency code.” In column 454, row 422, there is an operation code of “equals” (=), and in column 456, row 422, there is a value of “CNY” (Chinese Yuan). Thus, the third mapping condition includes a currency code equal to “CNY.” Note that while three mapping conditions are shown in FIG. 4, other embodiments may include more or fewer mapping conditions within an artifact and transaction type mapping table.

Referring now to row 424, it also shows three mapping conditions. In column 432, row 424, there is a condition of “Status.” In column 434, row 424, there is an operation code of “equals” (=), and in column 436, row 424, there is a value of “In stock.” Thus, the first mapping condition includes a status of “In stock.”

In column 442, row 424, there is a condition of “Business type.” In column 444, row 424, there is an operation code of “equals” (=), and in column 446, row 424, there is a value of “Metal trading.” Thus, the second mapping condition 410 includes a business type of “Metal trading.”

In column 452, row 424, there is a condition of “Minimum balance.” In column 454, row 424, there is an operation code of “greater than” (>), and in column 456, row 424, there is a value of “$2,000 USD.” Thus, the third mapping condition 412 includes a minimum balance that is greater than $2,000 USD. Other mapping conditions, operation codes, and values are possible in embodiments of the present invention. Such operation codes may include, but are not limited to, greater than (>), less than (<), greater than or equal to (=>), less than or equal to (<=), not (!=), logical AND (&&), logical OR (∥), logical exclusive OR (\hat{ }), and/or other suitable operation codes. The mapping conditions are processed by one or more processors within the computerized transaction optimization engine 102. The structure of the mapping conditions provides flexibility, in that values, operation codes, and/or conditions can be added and/or edited over time as accounting rules and products change.

In embodiments, mapping artifacts to transaction types comprises creating an artifact and transaction type mapping (ATMT) table. In embodiments, the ATMT includes a plurality of mapping condition entries. In embodiments, the plurality of mapping condition entries includes an investment type conditional assignment. In embodiments, the plurality of mapping condition entries includes a business type conditional assignment. In some embodiments, the conditional assignments may be established a priori via operator entry.

Column 414 comprises a transaction type. For the transaction type, column 414, row 422 includes a transaction type of “Individual monthly savings deposit.” Column 414, row 424 includes a transaction type of “Cash in stock.”

Column 416 comprises a transaction type group. For the transaction type group, column 416, row 422 includes a transaction type of “Interest-bearing deposit group.” Column 416, row 424 includes a blank entry, indicating a transaction type of NULL. In embodiments, some transaction types may not be associated with a transaction type group.

FIG. 5 is an exemplary transaction scenario categorization table 500 in accordance with embodiments of the present invention. In embodiments, the transaction scenario categorization table may be created by manual entry, and/or via computer-implemented techniques based on transaction metadata from other tables. Column 502 comprises a transaction type field. In column 502, row 522, a transaction type of “Unit time deposit” is shown. In column 502, row 524, a transaction type of “Unit time deposit” is also shown. While two rows are shown in transaction scenario categorization table 500, in practice, there can be many more rows, with each row corresponding to a different mapping between an artifact and a transaction type.

Column 504 comprises a transaction type group field (see column 214 of FIG. 2). In column 504, row 522, a transaction type group of “Interest bearing deposit group” is shown. In column 504, row 524, a transaction type group of interest bearing” is shown. In practice, there can be other transaction type groups that may be indicated. These can include, but are not limited to, a transaction type group of “tax” and/or a transaction type group of “internal account.”

Column 506 comprises an atomic action field. The atomic action represents a decomposition of transactions into the minimum granularity. In column 506, row 522, an atomic action of “Withdrawal” is shown. In column 506, row 524, an atomic action of “Payment” is shown. In practice, there can be other atomic actions that may be indicated.

Column 508 comprises an amount type field. The amount type is a categorization of the funds involved in a particular scenario. In column 508, row 522, an amount type of “Normal principal” is shown. In column 508, row 524, an amount type of “Loan interest” is shown. In practice, there can be other amount types that may be indicated.

Column 510 includes additional entry information. The entry information can include one or more balance types corresponding to each row of the transaction scenario categorization table 500. Column 532 comprises a first balance type. Column 534 comprises a second balance type. In practice, there can be more or fewer balance types within the entry information of a transaction scenario categorization table.

For the first balance type, column 542 comprises the loan sign (debit or credit), and column 544 comprises the balance type. In column 542, row 522, a loan sign of “Credit” is shown. In column 544, row 522, a corresponding balance type name of “Deposit principal” is shown. In column 542, row 524, a loan sign of “Debit” is shown. In column 544, row 524, a corresponding balance type name of “Deposit principal” is shown.

For the second balance type, column 546 comprises the loan sign (debit or credit), and column 548 comprises the balance type. In column 546, row 522, a loan sign of “Credit” is shown. In column 548, row 522, a corresponding balance type name of “Interest payment” is shown. In column 546, row 524, a loan sign of “Debit” is shown. In column 548, row 524, a corresponding balance type name of “Transaction fee” is shown. In practice, there can be other balance type names that may be indicated.

FIG. 6 is a diagram 600 indicating table relationships in accordance with embodiments of the present invention. Using a relational database, the account type group may be used as a field to associate the various tables for a given set of entries. The transaction scenario table 200 (see FIG. 2 for details) is related to the transaction type table 300 (see FIG. 3 for details), the artifact and transaction type mapping table (ATMT) 400 (see FIG. 4 for details), and the transaction scenario categorization table 500 (see FIG. 5 for details). Since the transaction type group column is present in each table, it can be used for queries including multiple tables. In embodiments utilizing SQL, an exemplary query can include:

### SELECT TransactionScenarioTable.TransactionScenario,

### ATMT.CategoryOfTransactionTypes, ATMT.TransactionType

### FROM TransactionScenarioTable

### INNER JOIN ATMT ON

### TransactionScenarioTable.TransactionTypeGroup=ATMT.TransactionTypeGroup;

In the example tables of FIG. 2 and FIG. 4, this can provide a result such as:
Cash Deposit—Salable Products—Interest-bearing group

The above query is exemplary, and other queries are possible in disclosed embodiments to enable additional extraction and joining of data from one or more tables. Additionally, embodiments can include receiving a new transaction scenario and entering the new transaction scenario in the transaction scenario table.

FIG. 7 is a flowchart 700 indicating process steps for embodiments of the present invention. At 750, a list of transaction scenarios is compiled. In embodiments, this information can originate from the enterprise computing system 112. At 752, a list of transaction types is identified. This can include, but is not limited to, cash in stock, and/or monthly deposit. At 754, a list of transaction subjects is identified. These can include, but is not limited to, principal, interest payment, and/or interest expenditure. At 756, a transaction scenario table is created. An example of such a table is shown in FIG. 2. At 758, a transaction type table is created. An example of such a table is shown in FIG. 3. At 760, artifacts are identified. In a banking context, the artifacts may be products. These can include various types of savings accounts, checking accounts, money market accounts, trading accounts, mutual fund accounts, retirement accounts, and so on. At 762, artifacts are mapped to transaction types using one or more processors within the computerized transaction optimization engine 102. The artifact and transaction type mapping table (ATMT) stores a mapping of artifact to transaction type. An example of such a table is shown in FIG. 4. At 763, a transaction scenario categorization table is created. An example of such a table is shown in FIG. 5. At 764, a transaction is processed. This can include, for example, a deposit or withdrawal of funds by a customer of the financial institution. At 766, based on the transaction, the transaction type table is updated with the appropriate subject information (as shown in FIG. 3B). The updated subject information can be based on information in the transaction scenario categorization table (FIG. 5). The transaction scenario categorization table is the source of recording rule parameters for the computerized transaction optimization engine. When a transaction occurs, the computerized transaction optimization engine (102) decides which subjects to record according to the defined accounting rules. In some embodiments, the process continues to 768, where a scenario analysis is generated. The scenario analysis can include a what-if scenario that compares various financial products, taking in to consideration, factors such as accounting rules, interest rates, currency types, currency exchange rates, and/or customer financial goals.

In some embodiments, the sequence indicated in FIG. 7 may be performed in a different order, or in some cases, one or more parts may be performed concurrently. In embodiments, identifying a list of subjects comprises identifying one or more subjects selected from the group consisting of: principal, interest, and fees.

FIG. 8 is a block diagram of an exemplary client device 800 (similar to client device 116 of FIG. 1). Device 800 can be a smartphone, tablet computer, or other computing device. Device 800 includes a processor 802, which is coupled to a memory 804. Memory 804 may include dynamic random-access memory (DRAM), static random-access memory (SRAM), magnetic storage, and/or a read only memory such as flash, EEPROM, optical storage, or other suitable memory. In some embodiments, the memory 804 may not be a transitory signal per se. Device 800 may further include storage 806. In embodiments, storage 806 may include one or more magnetic storage devices such as hard disk drives (HDDs). Storage 806 may additionally include one or more solid state drives (SSDs). Device 800 further includes user interface 808. This may be a display, such as an LED display, a touch-sensitive screen, a keyboard, a mouse, or any other suitable interface for a user to interact with device 800. The device 800 further includes a communication interface 810. The communication interface 810 may be a wired communication interface that includes Ethernet, Gigabit Ethernet, or the like. In embodiments, the communication interface 810 may include a wireless communication interface that includes modulators, demodulators, and antennas for a variety of wireless protocols including, but not limited to, Bluetooth™, Wi-Fi, and/or cellular communication protocols for communication over a computer network. The device 800 may be used by personnel at an institution, or by end users, to access services provided by the computerized transaction optimization engine 102.

FIG. 9 is an example of a scenario analysis 900 in accordance with embodiments of the present invention. In some embodiments, the computerized transaction optimization engine 102 may be used to generate a scenario analysis. A scenario analysis can be based on real-world conditions, reflecting an actual scenario that is taking place, or will take place. In other embodiments, a scenario analysis can be performed on a hypothetical scenario as part of a what-if analysis.

Scenario analysis 900 may be implemented on a user interface such as a computer display. Analysis 900 comprises an input section 901, and an output section 903. The input section 901 includes a variety of fields, including an account goal 902, a withdrawal frequency 904, a country of deposit 906, and an initial principal 908. These fields are exemplary, and other scenarios may include more, fewer, and/or different fields. In the example of FIG. 9, the account goal 902 is entered in field 912 as “Long Term Savings.” The withdrawal frequency 904 is entered in field 914 as “Quarterly.” The country of deposit 906 is entered in field 916 as “Canada.” The initial principal 908 is entered in field 918 as “$50,000 CAD.”

In embodiments, the input from section 901 is used as criteria for identifying artifacts from a ATMT based on an appropriate transaction group type, transaction type, or other suitable criteria. This may include performing one or more SQL operations such as JOIN operations on one or more of the aforementioned tables.

In output section 903, an exemplary output is shown, including three options: option 1 (940), option 2 (970), and option 3 (980). In embodiments, the user selects an option button (e.g., by clicking, tapping, swiping, etc.) to reveal additional details for that option. As shown in FIG. 9, additional details for option 1 (940) are shown in details pane 905. Details pane 905 includes a variety of fields, including an institution 952, an artifact 954, an interest rate 956, and an annual fee 958. These fields are exemplary, and other scenarios may include more, fewer, and/or different fields. In the example of FIG. 9, the institution 952 is indicated in field 962 as “ABC Bank.” The artifact 954 is entered in field 964 as “Enterprise Account.” The interest rate 956 is indicated in field 966 as “3.1%.” The annual fee 958 is entered in field 968 as “$50 CAD.” The data rendered in output section 903 is derived from the computerized transaction optimization engine 102 via computer-implemented methods and techniques. Furthermore, embodiments can include performing a scenario analysis for the new transaction scenario, based on the artifact and transaction type mapping table. In some embodiments, the scenario analysis may include evaluating different artifacts (products) from different institutions. In some embodiments, the scenario analysis may account for projected variations in currency values, stock indexes, fund values, interest rates, and/or other enterprise parameters in generating results that are displayed in the output section 903.

As can now be appreciated, disclosed embodiments provide techniques for enabling interaction between different systems when connecting the computerized transaction optimization engine, and can provide the flexible assembly of accounting rules without affecting the trading system, allowing a fast response to product innovation, that is scalable to support expansion and development of the trading system.

International business depends on high-quality global accounting standards. Furthermore, international businesses routinely invest large amounts of money abroad. It is therefore essential to comprehend the various similarities and differences between different accounting scenarios. These scenarios can be based on laws and regulations of a country or other jurisdiction, as well as policy variations between financial institutions and/or other corporations. The disclosed embodiments allow a user to manage and evaluate these complex situations.

Additionally, analysis and understanding of accounting rules facilitates better comparison between business entities on a global level, serving to improve transparency and increase trust in financial reporting, thereby helping to promote global trade and investment. Thus, disclosed embodiments improve the technical field of computerized financial systems. In particular, disclosed embodiments can reduce mistakes caused by human error, and enable better reconciliation amongst various accounting systems and rules. The improved consistency in rule evaluation allows for better decision making, and enables improved scenario analysis.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method for computerized transaction optimization, comprising:
compiling a list of transaction scenarios;
identifying a list of transaction types based on the transaction scenarios;
identifying a list of subjects from the transaction types;
creating a transaction scenario table, wherein the transaction scenario table includes an entry for transaction type;
forming a plurality of transaction type groups, wherein each transaction type group of the plurality of transaction type groups includes a plurality of transaction types;
creating a transaction type table, wherein the transaction type table includes the transaction type groups, and corresponding balance types;
identifying a list of artifacts for one or more institutions;
mapping artifacts to transaction types, wherein the transaction types are based on the transaction scenarios;
creating a transaction scenario categorization table, wherein the transaction scenario categorization table includes an entry for a balance type; and
updating the transaction type table in an electronic database with subject information based on the balance type of the transaction scenario categorization table in response to a processed transaction.

2. The method of claim 1, wherein mapping artifacts to transaction types comprises creating an artifact and transaction type mapping (ATMT) table.

3. The method of claim 1, wherein forming transaction type groups includes forming an interest-bearing deposit group.

4. The method of claim 3, wherein forming transaction type groups includes forming a tax group.

5. The method of claim 1, wherein identifying a list of subjects comprises identifying one or more subjects selected from the group consisting of: principal, interest, and fees.

6. The method of claim 2, further comprising:
receiving a new transaction scenario; and
entering the new transaction scenario in the transaction scenario table.

7. The method of claim 6, further comprising performing a scenario analysis for the new transaction scenario, based on the artifact and transaction type mapping table.

8. The method of claim 2, wherein the ATMT includes a plurality of mapping condition entries.

9. The method of claim 8, wherein the plurality of mapping condition entries includes an investment type conditional assignment.

10. The method of claim 8, wherein the plurality of mapping condition entries includes a business type conditional assignment.

11. An electronic computation device comprising:
a processor;
a memory coupled to the processor, the memory containing instructions, that when executed by the processor, cause the electronic computation device to:
compile a list of transaction scenarios;
identify a list of transaction types based on the transaction scenarios;
identify a list of subjects from the transaction types;
create a transaction scenario table, wherein the transaction scenario table includes an entry for transaction type;
form a plurality of transaction type groups, wherein each transaction type group of the plurality of transaction type groups includes a plurality of transaction types;
create a transaction type table, wherein the transaction type table includes the transaction type groups, and corresponding balance types;
identify a list of artifacts for one or more institutions;
map artifacts to transaction types, wherein the transaction types are based on the transaction scenarios;
create a transaction scenario categorization table, wherein the transaction scenario categorization table includes an entry for a balance type; and
update the transaction type table in an electronic database with subject information based on the balance type of the transaction scenario categorization table in response to a processed transaction.

12. The electronic computation device of claim 11, wherein the memory further comprises instructions, that when executed by the processor, cause the electronic computation device to create an artifact and transaction type mapping (ATMT) table.

13. The electronic computation device of claim 12, wherein the memory further comprises instructions, that when executed by the processor, cause the electronic computation device to
receive a new transaction scenario; and
enter the new transaction scenario in the transaction scenario table.

14. The electronic computation device of claim 13, wherein the memory further comprises instructions, that when executed by the processor, cause the electronic computation device to perform a scenario analysis for the new transaction scenario, based on the artifact and transaction type mapping table.

15. The electronic computation device of claim 11, wherein the memory further comprises instructions, that when executed by the processor, cause the electronic computation device to perform an investment type conditional assignment.

16. The electronic computation device of claim 11, wherein the memory further comprises instructions, that when executed by the processor, cause the electronic computation device to perform a business type conditional assignment.

17. A computer program product for an electronic computation device comprising a computer readable storage medium having program instructions embodied therewith, the program instructions executable by a processor to cause the electronic computation device to:
compile a list of transaction scenarios;
identify a list of transaction types based on the transaction scenarios;
identify a list of subjects from the transaction types;
create a transaction scenario table, wherein the transaction scenario table includes an entry for transaction type;
form a plurality of transaction type groups, wherein each transaction type group of the plurality of transaction type groups includes a plurality of transaction types;
create a transaction type table, wherein the transaction type table includes the transaction type groups, and corresponding balance types;
identify a list of artifacts for one or more institutions;
map artifacts to transaction types, wherein the transaction types are based on the transaction scenarios;
create a transaction scenario categorization table, wherein the transaction scenario categorization table includes an entry for a balance type; and
update the transaction type table in an electronic database with subject information based on the balance type of the transaction scenario categorization table in response to a processed transaction.

18. The computer program product of claim 17, wherein the computer readable storage medium includes program instructions executable by the processor to cause the electronic computation device to create an artifact and transaction type mapping (ATMT) table.

19. The computer program product of claim 18, wherein the computer readable storage medium includes program instructions executable by the processor to cause the electronic computation device to:
receive a new transaction scenario; and
enter the new transaction scenario in the transaction scenario table.

20. The computer program product of claim 19, wherein the computer readable storage medium includes program instructions executable by the processor to cause the electronic computation device to perform a scenario analysis for the new transaction scenario, based on the artifact and transaction type mapping table.
